(19) United States
(12) Patent Application Publication
(10) Pub. No.: US 2015/0167925 A1
(43) Pub. Date: Jun. 18, 2015

(54) LENS, OMNIDIRECTIONAL ILLUMINATION DEVICE AND RETROFIT LAMP INCLUDING THE LENS

(71) Applicant: OSRAM GmbH, Muenchen (DE)

(72) Inventors: XueQin Lin, Shanghai (CN); Tobias Schmidt, Augsburg (DE); YingJun Cheng, Shanghai (CN)

(21) Appl. No.: 14/408,306

(22) PCT Filed: Jun. 12, 2013
(86) PCT No.: PCT/EP2013/062191

§ 371 Date: Dec. 16, 2014

(30) Foreign Application Priority Data
Jun. 19, 2012 (CN) 201210208608.4

(51) Int. Cl. F21V 5/04; F21K 99/00; F21V 29/70

(52) U.S. Cl. CPC F21V 5/04; F21V 29/70; F21K 9/135; F21Y 2101/02

(57) ABSTRACT

Various embodiments relate to a lens for omnidirectional illumination which is rotationally symmetrical and includes a light incident surface, a first light refractive surface, a first light reflective surface, and a second light refractive surface designed to be rotationally symmetrical, respectively. The second light refractive surface is defined by a Bezier curve in a cross section, a first portion of light through the light incident surface is refracted by the first light refractive surface, a second portion of the light through the light incident surface is reflected by the first light reflective surface to the second light refractive surface, and then is refracted by the second light refractive surface, a third portion of the light through the light incident surface is refracted by the second light refractive surface, to produce first, second and third emergent lights, respectively. The first, second and third emergent lights jointly achieve omnidirectional illumination.

### RELATED APPLICATIONS

The present application is a national stage entry according to 35 U.S.C. §371 of PCT application No.: PCT/EP2013/062191 filed on Jun. 12, 2013, which claims priority from Chinese application No.: 201210208608.4 filed on Jun. 19, 2012, and is incorporated herein by reference in its entirety.

### TECHNICAL FIELD

Various embodiments relate to a lens, an omnidirectional illumination device and a retrofit lamp including the lens.

### BACKGROUND

With the advantages of long life, energy saving, environmental friendliness and shake-resistance, the LED light sources can be applied in a wide area. With the development of manufacture technology, the cost of the LEDs becomes lower and lower, and the optical efficiency is increased a lot. It is a trend that solid-state lighting (SSL) replaces the traditional lighting devices.

The US Energy Star criteria have certain requirements for omnidirectional SSL replacement lamps. Within 0° to 135° zone, luminous intensity at any angle shall not differ from the mean luminous intensity for the entire 0° to 135° zone by more than 20%. Luminous flux within 135° to 180° zone shall occupy at least 5% of the total luminous flux. Measurement results should be the same in vertical plane 45° and 90° from the initial plane. Most of the LEDs' intensity distribution is lambertian rather than uniform, so secondary optical design is indispensable. For SSL replacement lamps, in order to meet those requirements, it is essential to design optical components to redistribute light.

In the related art, there are many solutions to get light source redistribution for LED lamps. The first solution is optimizing LEDs' array, and the second solution is using reflector to redistribute light.

In the field of illumination device, an omnidirectional illumination device can realize an illumination effect in a large area, and thus has a large prospect of application. A class of illumination devices among the prior omnidirectional illumination devices has a three-dimensional light source such as an array of LED chips directly arranged at the center of a lamp housing, and such light sources arranged in a cylindrical or disc array can illuminate in a circumferential direction of 360°. Light emitted from the light source is directly emitted through the lamp housing, thus an omnidirectional illumination effect is simply realized. Such an omnidirectional illumination device is, for example, disclosed by EP2180234A1 and WO2009/091562A2. However, when one or more light sources of the light source array are broken, the omnidirectional illumination effect cannot be realized any more. Since it is necessary to mount a plurality of light sources in the illumination device and electrically connect each of these light sources to a circuit board, the illumination device consumes a large amount of electric energy and generates too much heat. In order to improve the effect of radiating heat from the cylindrical light source array, it is for example possible to arrange, on an outer circumferential surface of the cylindrical light source array, a heat sink such as a plurality of heat sink ribs, which is, for example, disclosed in WO2010/058325A1. However, it requires high cost in both the manufacture or assembling and the use or maintenance of the above illuminative device. Another kind of omnidirectional illumination device realizes the omnidirectional illumination effect by using the reflection principle. Patent Document WO2009/059125A1 discloses an illumination device, in which a single light source is arranged in a bottom region of a basin-shaped reflector so that light can be reflected by means of a reflective surface of the reflector toward an area as large as possible, while the reflector must be ensured to have a large enough reflective surface. Hence, such illumination device has a large volume.

Among all of the above solutions, no solution is proposed for achieving omnidirectional illumination through the design of a lens.

### SUMMARY

Therefore, various embodiments provide a lens for omnidirectional illumination which can eliminate the defects of the various solutions in the related art and has the advantages of low manufacturing cost, simple manufacturing process, uniform light distribution, and omnidirectional illumination.

According to various embodiments, a lens is provided, characterized in that, the lens is rotationally symmetrical and includes a light incident surface, a first light refractive surface, a first light reflective surface, and a second light refractive surface designed to be rotationally symmetrical, respectively, wherein the second light refractive surface is defined by a Bezier curve in a cross section, a first portion of light passing through the light incident surface is refracted by the first light refractive surface to produce first emergent light, a second portion of the light passing through the light incident surface is reflected by the first light reflective surface to the second light refractive surface, and then is refracted by the second light refractive surface to produce second emergent light, a third portion of the light passing through the light incident surface is refracted by the second light refractive surface to produce third emergent light, and the first emergent light, the second emergent light and the third emergent light jointly achieve omnidirectional illumination.

According to various embodiments, omnidirectional illumination is provided by designing the lens to have a plurality of refractive surfaces and reflective surfaces. The first emergent light for forward illumination which is close to an optical axis is provided through the first refractive surface, the third emergent light which is, in particular, achieved through the second light refractive surface having a profile defined by a Bezier curve achieves backward illumination which is different from the forward illumination, the second emergent light for backward illumination which forms a large angle with the optical axis is provided by the cooperation of the first light reflective surface and the second light refractive surface to supplement the third emergent light, and thereby, omnidirectional illumination is provided.

According to various embodiments, the lens includes a bottom surface, a top surface, and a side surface connecting the top surface and the bottom surface, and the side surface is the second light refractive surface and has a profile extending in an arc from the bottom surface and the top surface towards an optical axis. An illumination region of light is affected by the cooperation of the bottom surface, the top surface and the second light refractive surface designed as the side surface, and thereby the effect of omnidirectional illumination can be achieved.

It is proposed according to various embodiments that, in a cross section, the second light refractive surface is defined by a Bezier curve. When the cross sectional profile of the second light refractive surface can be described by a Bezier curve, the sidewall of the lens is smooth.

It is proposed according to various embodiments that, the second light refractive surface includes a first refractive sub-surface connected with the top surface and a second refractive sub-surface connected with the bottom surface each of which is defined by a Bezier curve, in a cross section. When the second light refractive surface is defined by two Bezier curves arranged opposite to each other in a cross section, an intersection between the two curves in the central portion of the lens is closer to the optical axis than the edge of the top surface and/or the bottom surface.

In various embodiments, the top surface includes the first light refractive surface, the first light reflective surface and a first horizontal surface located at the edge of the top surface which concentrically surround the optical axis in a series. Thus, forward illumination within the center of the top region is achieved using the first light refractive surface. Further, it is more convenient for the first light reflective surface to cooperate with the second light refractive surface in the side direction. The numerical value of an inclination angle of the second light refractive surface with respect to the bottom and top surfaces and the degree at which the second light refractive surface inclinedly extends towards the center of the lens depend on the size, position and specific profile of the first light reflective surface. The general principle is that the emergence range of the second emergent light shall comply with the expected light distribution.

In various embodiments, a curved surface formed by connecting the first light refractive surface located in the center and the first light reflective surface has a profile defined by a Bezier curve in a cross section. The smooth curved surface composed of the first light refractive surface and the first light reflective surface is recessed towards a light source in a direction of the optical axis. In a cross section of the lens, the first light refractive surface has a small area, and has an edge which forms an angle of 0° to 5° with the optical axis; and the first light reflective surface has a larger area than the first light refractive surface, and has a small-diameter edge connected with the first light refractive surface and a large-diameter edge connected with an inner edge of the annular first horizontal surface. This design further optimizes the cooperation of the first light reflective surface and the second light refractive surface.

In various embodiments, the bottom surface has a recess at the center surrounding the optical axis, an inner surface of the recess is formed as the light incident surface, and a remaining region is a planar second horizontal surface. The third portion of the light passing through the light incident surface is refracted by the second light refractive surface. In this way, the recessed light incident surface provides an accommodation cavity for a light source, and the planar second horizontal surface other than the light incident surface provides convenience for arranging a lens.

In various embodiments, the light incident surface includes a first curved surface located in the center and a second curved surface extending from the first curved surface to the second horizontal surface, the first curved surface being recessed away from the second horizontal surface in a direction of the optical axis. Thus, the first and second portions of light from the light source are emitted towards the first light refractive surface and the first light reflective surface through the first curved surface with a certain curvature, respectively, and thereby forward illumination is provided by the first light refractive surface, and backward illumination and part of side illumination are provided by the first light reflective surface.

In various embodiments, the first curved surface has a profile defined by a Bezier curve in a cross section. The first curved surface and the curved surface composed of the first light refractive surface and the first light reflective surface are arranged opposite to each other, wherein a projection-width of the curved surface composed of the first light refractive surface and the first light reflective surface in a direction perpendicular to the optical axis is greater than a width of the first curved surface.

In various embodiments, the second curved surface has a cylindrical or truncated cone-shaped profile. The third emergent light is refracted towards the second light refractive surface through the second curved surface, so that the third emergent light thus produced covers an illumination region as large as possible in a side direction of the lens that is perpendicular to the optical axis.

In various embodiments, the light incident surface is an arc surface in a cross section. More preferably, the light incident surface is a semicircular surface in a cross section. This tries not to change the distribution of the light from the light source.

In various embodiments, the first horizontal surface is a refractive surface or a diffuse reflective surface. And, the second horizontal surface is a refractive surface or a diffuse reflective surface. A small amount of light can be directly refracted through the first horizontal surface to achieve forward illumination, and light reflected by the first light reflective surface can be directly refracted through the second horizontal surface to achieve backward illumination. The first and second horizontal surfaces are coated with a diffuse reflective layer, thus the effect of Fresnel reflection inside the lens can be affected, and thereby the light distribution effect of the lens is improved to obtain comfortable and soft emergent light.

According to various embodiments, an omnidirectional illumination device including a directional light source and a lens having the above features is provided, so as to omnidirectionally distribute the light from the directional light source by using the lens.

In various embodiments, the heat sink includes a main body and a plurality of heat sink fins extending from the main body, one end of the main body supports the light source, and the lens covers the light source. The main body is designed, for example, as a hollow cylinder in which other members can be contained. The heat sink fins can be arranged, in one piece or as additional members, on the main body. The heat sink fins may be formed in the circumferential direction thereof with a supporting and/or limiting structure for the lens and the light source.

In various embodiments, the lamp housing and the heat sink are fixedly connected with jointly define a cavity accommodating the light source and the lens.

In various embodiments, the other end of the main body is connected with the lamp socket. Thus, a current can be supplied to the light source.

Further, Various embodiments relate to a retrofit lamp including an omnidirectional illumination device as described above, wherein the light source of the omnidirectional illumination device is an LED chip. The retrofit lamp according to various embodiments has the advantages of low manufacturing cost, simple manufacturing process, uniform light distribution, and omnidirectional illumination.

Various embodiments further relate to a method of manufacturing a lens described above, including the steps of: a) providing a mold having a sidewall defined by a Bezier curve in a cross section; b) pouring into the mold a liquid material for manufacturing the lens; and c) cooling and removing the mold to obtain the lens.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 is a cross sectional view of a first embodiment of the lens according to the present disclosure;

FIG. 2 is a schematic diagram of emergent light of the first embodiment of the lens according to the present disclosure;

FIG. 3 is a first 3D view of the first embodiment of the lens according to the present disclosure;

FIG. 4 is a second 3D view of the first embodiment of the lens according to the present disclosure;

FIG. 5 is a schematic diagram showing light distribution of the emergent light of the first embodiment of the lens according to the present disclosure;

FIG. 6 is a graph showing light distribution of the emergent light of the first embodiment of the lens according to the present disclosure;

FIG. 7 is a cross sectional view of a second embodiment of the lens according to the present disclosure; and

FIGS. 8-10 are schematic diagrams of a first embodiment of the omnidirectional illumination device according to the present disclosure.

### DETAILED DESCRIPTION

The following detailed description refers to the accompanying drawing that show, by way of illustration, specific details and embodiments in which the disclosure may be practiced.

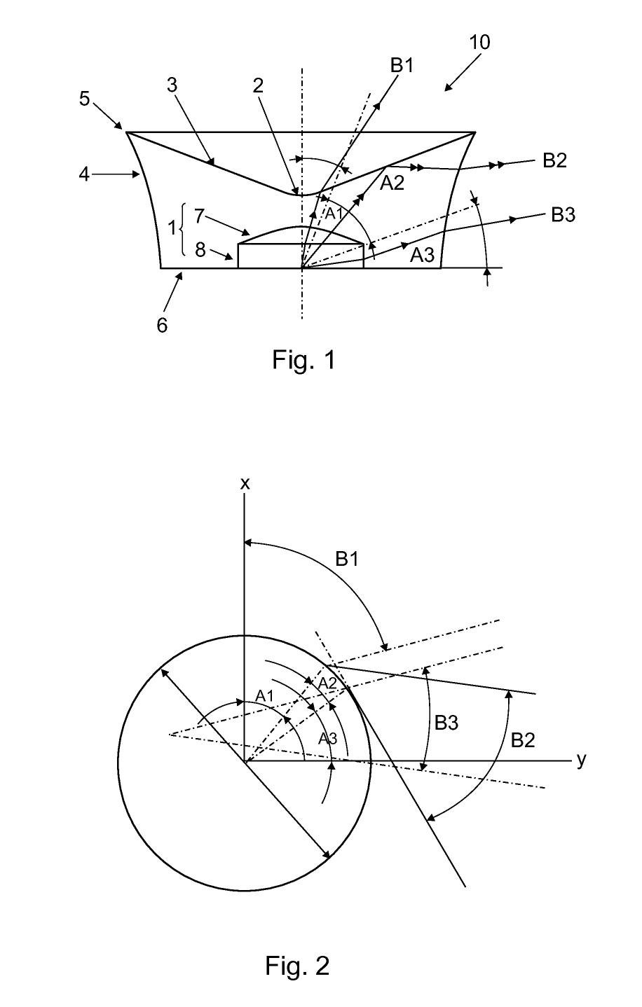

FIG. 1 is a cross sectional view of a first embodiment of the lens according to the present disclosure. The lens 10 according to the present disclosure is designed to be rotationally symmetrical with respect to an optical axis. Thus, FIG. 1 illustrates a complete profile of the lens 10 according to the present disclosure finally formed by rotation. The cross-sectional profile of the lens 10 includes a top edge, a bottom edge and side edges connecting the top edge and the bottom edge. After being rotated, the top edge, the bottom edge and the side edges form a top surface, a bottom surface, and a side surface connecting the top surface and the bottom surface of the lens 10.

In the present embodiment, the top surface symmetrical with respect to the optical axis includes, in a series from the center to the edge, a first light refractive surface 2, a first light reflective surface 3, and a first horizontal surface 5 located at the edge, and the side surface is a second light refractive surface 4 having a profile that can be defined by a Bezier curve in the figure. The second light refractive surface 4 has a top end connected with the first horizontal surface 5 and a bottom end connected with a second horizontal surface 6 on the bottom surface. The second refractive surface 4 has a trend of extending smoothly, and is slightly recessed towards the optical axis in the central region of the lens 10 and has a profile similar to an hourglass as viewed in a longitudinal direction.

As can be seen from FIG. 1, light passing through alight incident surface 1 is divided into three portions, viz. a first portion A1, a second portion A2, and a third portion A3. The first portion A1 corresponds to the first light refractive surface 2 which is used for refracting the first portion A1. The second portion A2 corresponds to the first light reflective surface 3 and a part of the second light refractive surface 4, and the second portion A2 of the light passing through the light incident surface 1 is emitted onto the first light reflective surface 3, and is reflected by the first light reflective surface 3 to the second light refractive surface 4, and then is emitted after being refracted by the second light refractive surface 4. The third portion A3 corresponds to the other part of the second light refractive surface 4 which is used for refracting the third portion A3.

As can be seen from FIG. 1, the bottom surface of the lens 10 is partially curved to form the light incident surface 1 for a light source. The bottom surface includes a concave light incident surface 1 located in the center, and a planar second horizontal surface 6 located at the edge and surrounding the light incident surface 1. The light incident surface 1 forms an accommodation cavity for a light source. The light passing through the light incident surface 1 produces three portions of light as mentioned above, viz. the first portion A1, the second portion A2, and the third portion A3. In order to try not to change the direction of the light from the light source, the light incident surface 1 includes a first curved surface 7 located at the center of the bottom surface and a second curved surface 8 extending downward from the first curved surface 7 to the second horizontal surface 6 in the optical axis direction. The first curved surface 7 preferably also has a profile defined by Bezier curve, and the apex of the first curved surface 7 is closer to the apex of the first light refractive surface 2 than the edge region of the first curved surface 7. In the present embodiment, the second curved surface 8 has sidewalls parallel to each other in a cross section, that is, the second curved surface 8 has a cylindrical shape.

In an embodiment not shown, the second curved surface 8 may have a sidewall inclined towards the optical axis in a cross section, that is, the second curved surface 8 has a truncated cone-shaped profile.

FIG. 2 is a schematic diagram of emergent light of the first embodiment of the lens according to the present disclosure. As can be seen from the figure, the emergent light includes three portions, viz. first emergent light B1, second emergent light B2, and third emergent light B3. The three portions of emergent light B1, B2 and B3 respectively correspond to the three portions of the light passing through the light incident surface 1, viz. the first portion A1, the second portion A2, and the third portion A3. The first portion A1 produces the first emergent light B1, and the first emergent light B1 is forward illumination on the top portion in the first quadrant. The second portion A2 produces the second emergent light B2, and the second emergent light B2 is backward illumination partially covering the first quadrant and the fourth quadrant. The third portion A3 produces the third emergent light B3, and the third emergent light B3 is backward illumination at the sides. FIG. 2 merely illustrates a schematic diagram of emergent light in one quadrant. As the lens according to the present disclosure is rotationally symmetrical, improved illumination is finally achieved by overlapping of emergent light in a circumferential direction of the lens.

The light incident surface is an arc surface in a cross section. In the present embodiment, the light incident surface 1 is a semicircular surface in a cross section.

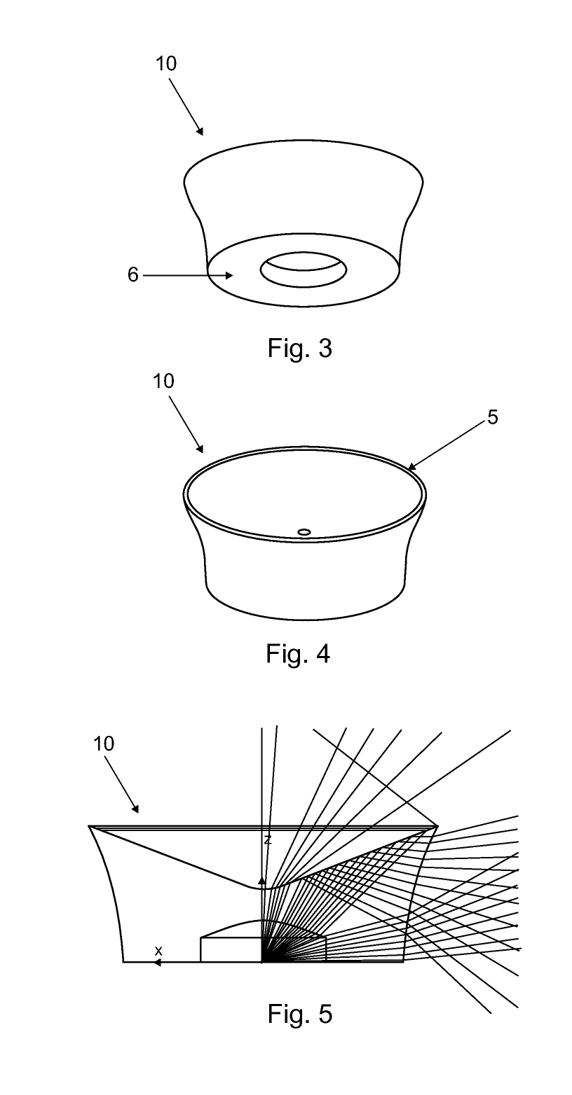

FIG. 3 and FIG. 4 are respectively first and second 3D views of the first embodiment of the lens according to the present disclosure. In order to influence the effect of Fresnel reflection inside the lens 10, each of the first and second horizontal surfaces 5 and 6 of the lens 10 according to the present disclosure is designed as a diffuse reflective surface coated with a reflective material which may be, for example, white paint, thus light emitted through the lens can become softer so as to be easily accepted by a user.

FIG. 5 is a schematic diagram showing light distribution of the emergent light of the first embodiment of the lens according to the present disclosure. As can be seen from the figure, the lens 10 according to the present disclosure substantially achieves omnidirectional illumination.

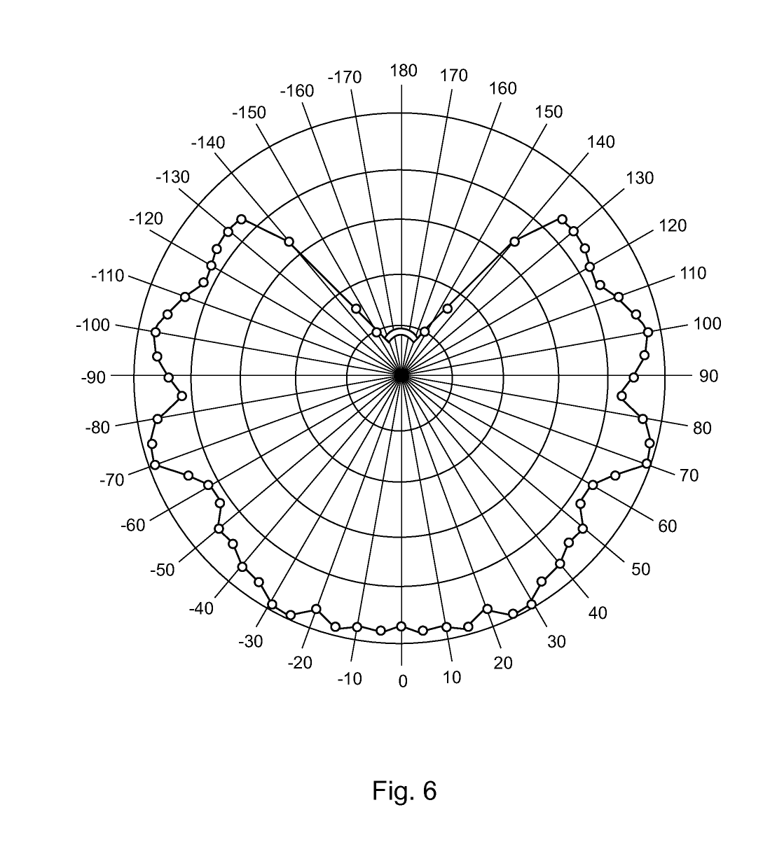

FIG. 6 is a diagram showing light distribution of the emergent light of the first embodiment of the lens according to the present disclosure, wherein the luminous intensity distribution is uniform in the range of −140° to 140°.

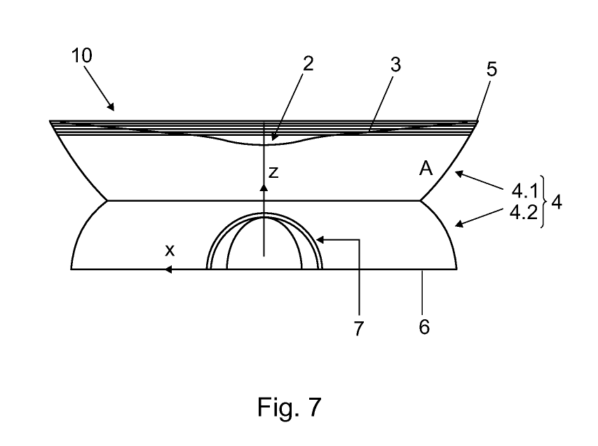

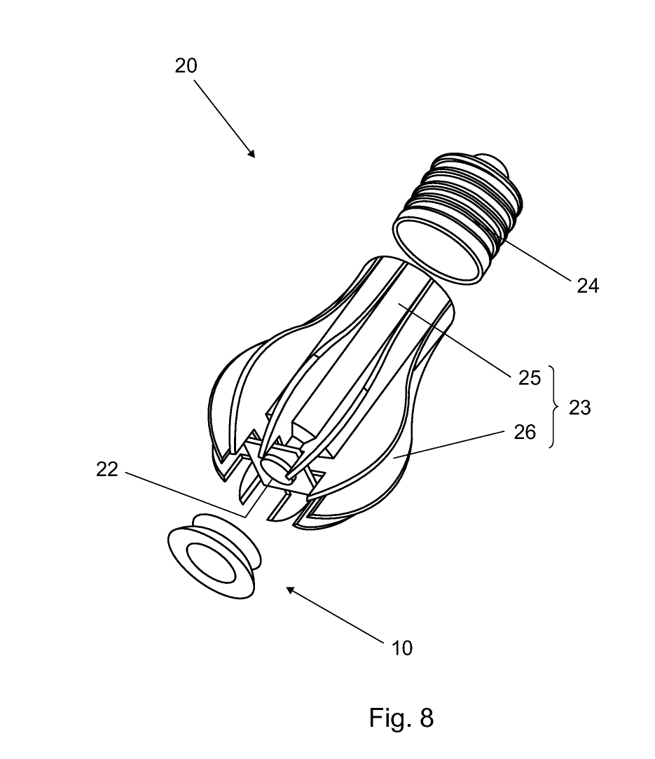

FIG. 7 is a cross sectional view of a second embodiment of the lens according to the present disclosure. The lens 10 in the second embodiment differs from that illustrated in the first embodiment in that the sidewall of the lens 10 is respectively obtained by rotating two Bezier curves symmetrical. A first refractive sub-surface 4.1 connected with the first horizontal surface 5 and a second refractive sub-surface 4.2 connected with the second horizontal surface 6 respectively smoothly extend towards the optical axis and intersect at point A. Thus, a lens 10 that can be divided into two parts is formed, a first part is a first spherical crown formed by the rotation of the first light refractive surface 2, the first light reflective surface 3, the first horizontal surface 5 and the first refractive sub-surface 4.1, and a second part is a second spherical crown formed by the rotation of the second refractive sub-surface 4.2 and the bottom surface. Moreover, the light incident surface 1 in the present embodiment preferably has a semicircular cross section.

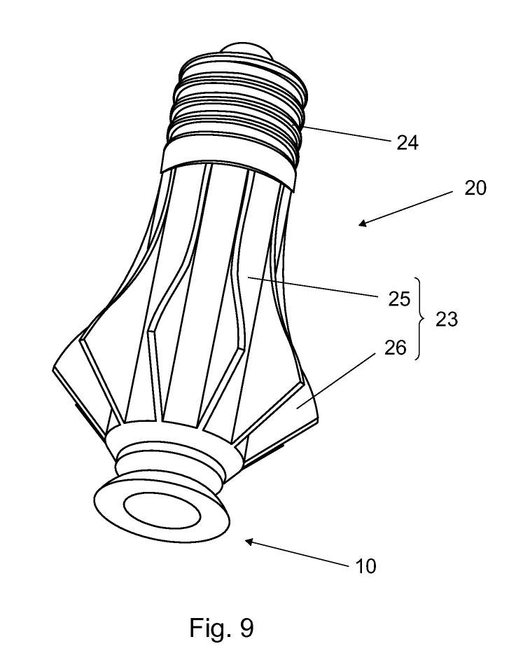

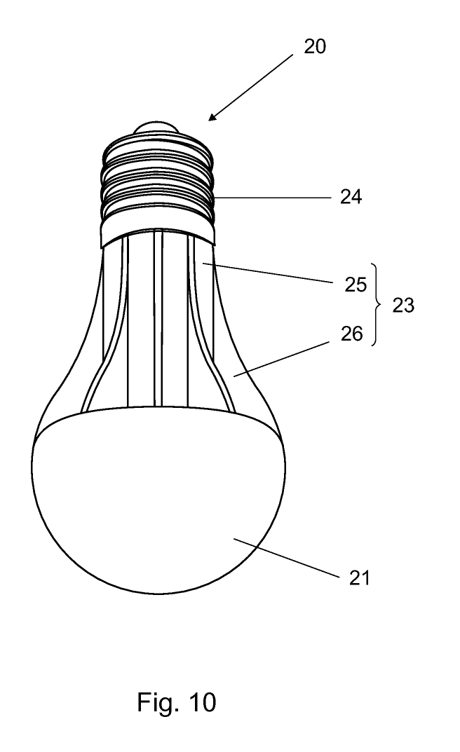

FIGS. 8-10 are schematic diagrams of the first embodiment of the omnidirectional illumination device 20 according to the present disclosure. The omnidirectional illumination device 20 is a retrofit lamp including a lamp housing 21, a heat sink 23 having an end supporting a light source 22 which is an LED chip, and a lamp socket 24, wherein the lamp housing 21 and the heat sink 23 jointly define a space accommodating the light source 22 and a lens 10 covering the light source 22. The heat sink 23 includes a main body 25 and a plurality of heat sink fins 26 extending in a circumferential direction thereof. Since the light source 22 is accommodated in a recessed region of the lens 10, the lens 10 can be designed to have different sizes according to the size of the light source to reduce the structural space.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

### LIST OF REFERENCE SIGNS

1 light incident surface
2 first light refractive surface
3 first light reflective surface
4 second light refractive surface
4.1 first refractive sub-surface
4.2 second refractive sub-surface
5 first horizontal surface
6 second horizontal surface
10 lens
20 omnidirectional illumination device
21 lamp housing
22 light source
23 heat sink
24 lamp socket
25 main body
26 heat sink fins
A1 first portion
A2 second portion
A3 third portion
B1 first emergent light
B2 second emergent light
B3 third emergent light

1. A lens for omnidirectional illumination,
being rotationally symmetrical and comprising:
a light incident surface, a first light refractive surface, a first light reflective surface, and
a second light refractive surface designed to be rotationally symmetrical, respectively,
wherein the second light refractive surface is defined by a Bezier curve in a cross section, a first portion of light passing through the light incident surface is refracted by the first light refractive surface to produce first emergent light, a second portion of the light passing through the light incident surface is reflected by a first light reflective surface to the second light refractive surface, and then is refracted by the second light refractive surface to produce second emergent light, a third portion of the light passing through the light incident surface is refracted by the second light refractive surface to produce third emergent light, and the first emergent light, the second emergent light and the third emergent light jointly achieve omnidirectional illumination.

2. The lens according to claim 1,
wherein the lens comprises a bottom surface, a top surface, and a side surface connecting the top surface and the bottom surface, and the side surface is the second light refractive surface and has a profile extending in an arc from the bottom surface and the top surface towards an optical axis.

3. The lens according to claim 2,
wherein in a cross section, the second light refractive surface is defined by a Bezier curve.

4. The lens according to claim 2,
wherein the second light refractive surface comprises a first refractive sub-surface connected with the top surface and a second refractive sub-surface connected with the bottom surface each of which is defined by a Bezier curve, in a cross section.

5. The lens according to claim 2,
wherein the top surface comprises the first light refractive surface, the first light reflective surface and a first horizontal surface located at the edge of the top surface which concentrically surround the optical axis in a series.

6. The lens according to claim 5,
wherein a curved surface formed by connecting the first light refractive surface located in the center and the first light reflective surface has a profile defined by a Bezier curve in a cross section.

7. The lens according to claim 5,
wherein the first horizontal surface is a refractive surface or a diffuse reflective surface.

8. The lens according to claim 2,
wherein the bottom surface has a recess at the center surrounding the optical axis, an inner surface of the recess is formed as the light incident surface, and a remaining region is a planar second horizontal surface.

9. The lens according to claim 8,
wherein the light incident surface comprises a first curved surface located in the center and a second curved surface extending from the first curved surface to the second horizontal surface, the first curved surface being recessed away from the second horizontal surface in a direction of the optical axis.

10. The lens according to claim 9,
wherein the first curved surface has a profile defined by a Bezier curve in a cross section.

11. The lens according to claim 9,
wherein the second curved surface has a cylindrical or truncated cone-shaped profile.

12. The lens according to claim 8,
wherein the light incident surface is an arc surface in a cross section.

13. The lens according to claim 5,
wherein the second horizontal surface is a refractive surface or a diffuse reflective surface.

14. An omnidirectional illumination device comprising:
a lamp housing,
a light source,
a heat sink,
a lamp socket, and
a lens
the lens comprising:
a light incident surface, a first light refractive surface, a first light reflective surface, and a second light refractive surface designed to be rotationally symmetrical, respectively,
wherein the second light refractive surface is defined by a Bezier curve in a cross section, a first portion of light passing through the light incident surface is refracted by the first light refractive surface to produce first emergent light, a second portion of the light passing through the light incident surface is reflected by a first light reflective surface to the second light refractive surface, and then is refracted by the second light refractive surface to produce second emergent light, a third portion of the light passing through the light incident surface is refracted by the second light refractive surface to produce third emergent light, and the first emergent light, the second emergent light and the third emergent light jointly achieve omnidirectional illumination.

15. The omnidirectional illumination device according to claim 14,
wherein the heat sink comprises a main body and a plurality of heat sink fins extending from the main body, one end of the main body supports the light source, and the lens covers the light source.

16. The omnidirectional illumination device according to claim 15,
wherein the lamp housing and the heat sink are fixedly connected with jointly define a cavity accommodating the light source and the lens.

17. The omnidirectional illumination device according to claim 15,
wherein the other end of the main body is connected with the lamp socket.

18. A retrofit lamp comprising an omnidirectional illumination device,
the omnidirectional illumination device comprising:
a lamp housing,
a light source,
a heat sink,
a lamp socket, and
a lens,
the lens comprising:
a light incident surface, a first light refractive surface, a first light reflective surface, and a second light refractive surface designed to be rotationally symmetrical, respectively,
wherein the second light refractive surface is defined by a Bezier curve in a cross section, a first portion of light passing through the light incident surface is refracted by the first light refractive surface to produce first emergent light, a second portion of the light passing through the light incident surface is reflected by a first light reflective surface to the second light refractive surface, and then is refracted by the second light refractive surface to produce second emergent light, a third portion of the light passing through the light incident surface is refracted by the second light refractive surface to produce third emergent light, and the first emergent light, the second emergent light and the third emergent light jointly achieve omnidirectional illumination,
wherein the light source of the omnidirectional illumination device is an LED chip.
